(19) United States
(12) Patent Application Publication
(10) Pub. No.: US 2026/0183857 A1
(43) Pub. Date: Jul. 2, 2026

(54) METHOD FOR PRODUCING AND/OR PROCESSING A CONTINUOUS BELT COMPRISING A BELT BODY MADE OF METAL

(71) Applicant: Berndorf Band GmbH, Berndorf (AT)

(72) Inventor: Christian HOLZER, Walpersbach (AT)

(73) Assignee: Berndorf Band GmbH, Berndorf (AT)

(21) Appl. No.: 18/846,815

(22) PCT Filed: Apr. 6, 2023
(86) PCT No.: PCT/AT2023/060119

§ 371 Date: Sep. 13, 2024

(30) Foreign Application Priority Data
Apr. 8, 2022 (AT) A50230/2022

(51) Int. Cl. B23K 9/035

(52) U.S. Cl. CPC B23K 9/0356

(57) ABSTRACT

In a method for producing and/or processing a continuous belt and a continuous belt including a belt body made of metal, at least two sections of the belt body are connected together by welding. Prior to welding of the at least two sections a step i) is carried out in which a welding gap formed in the abutting region of the at least two sections is covered by a cover, and a subsequent step ii) is carried out in which a fluxing agent is applied in one region of the belt body, the region directly adjoining the cover and not being covered by the cover. In a subsequent step iii), the cover is removed, and in a step iv), the at least two sections are welded together along the welding gap.

### CROSS REFERENCE TO RELATED APPLICATIONS

This application is the National Stage of PCT/AT2023/060119 filed on Apr. 6, 2023, which claims priority under 35 U.S.C. § 119 of Austrian Application No. A50230/2022 filed on Apr. 8, 2022, the disclosure of which is incorporated by reference. The international application under PCT article 21(2) was not published in English.

### BACKGROUND OF THE INVENTION

### 1. Field of the Invention

The invention relates to a method for producing and/or processing a continuous belt comprising a belt body made of metal, wherein at least two sections of the belt body are connected together by welding.

The invention also relates to a continuous belt comprising a belt body made of metal.

### 2. Description of the Related Art

A relevant continuous belt is known from EP 1812191 B1.

When closing an open metal belt to form a continuous belt, free end sections of the metal belt may be welded together by means of a so-called transverse welding seam, which usually runs diagonally or transversely to a circumferential direction of the continuous belt. A fluxing agent is usually used to ensure through-welding and a continuous welding seam from the outside of the continuous belt to the inside of the continuous belt.

The disadvantage of applying the fluxing agent directly to the welding gap is that notches can form in the welding seam due to the so-called Marangoni effect, which can lead to significant deviations in flatness and thickness in one region of the welding seam compared to other regions of the continuous belt.

### SUMMARY OF THE INVENTION

The object of the present invention was to overcome the disadvantages of the prior art and to improve the quality of the welding seam.

This object is solved by a method of the type mentioned above in that prior to welding of the at least two sections a step i) is carried out in which a welding gap formed in the abutting region of the at least two sections is covered by a cover, wherein in a subsequent step ii) is carried out in which a fluxing agent is applied in one region of the belt body, said region directly adjoining the cover and not being covered by the cover, wherein in a subsequent step iii), the cover is removed, and in a step iv), the at least two sections are welded together along the welding gap, wherein the cover has a width transverse to a longitudinal course of the welding gap of between 2 mm and 150 mm.

The solution according to the invention enables the production of a significantly improved welding seam, wherein thickness and flatness deviations can be significantly reduced. Furthermore, a welding seam with a very small width can be realized. In addition, the invention enables optimum handling of the cover and at the same time low fluxing agent consumption, since preferably more fluxing agent is applied as the distance between a fluxing agent edge and the welding gap increases.

Preferably the cover may be a film, in particular a plastic film, preferably an adhesive tape or plastic belt, the film preferably being a transparent film with a transmittance of between 20% and 99%. A high degree of transmission or good transparency of the cover makes it much easier to position the cover precisely on the welding gap.

Particularly favorable with regard to achieving a small welding seam width is the fact that the fluxing agent applied in step ii) comprises 20-60% by weight TiOₓ and/or 0-5% by weight Cr₃Oₓ. This variant of the invention enables good through-welding and the realization of a small welding seam width even when joining end sections of very thick belt bodies.

Advantageously, the fluxing agent may be applied, for example, by spraying and/or brushing and/or rolling and/or printing. Since the cover prevents the fluxing agent from being applied directly to the welding gap, this variant of the invention allows the fluxing agent to be applied particularly quickly and easily. For example, the fluxing agent may also be sprayed, brushed, etc. onto the cover during application, wherein the fluxing agent on the cover is also removed after the cover is removed and the fluxing agent remaining on the belt surface is at a distance from the welding gap.

To achieve particularly narrow and deep welding seams of high quality, it has proven advantageous to use a TIG welding process, a PA welding process, a MIG welding process, a MAG welding process, a laser welding process or a plasma welding process in step iv).

In order to achieve an continuous belt with a low flatness and thickness deviation over its entire belt circumference and its entire belt width as well as high mechanical load-bearing capacity, it may be provided that the at least two sections form free end regions of the belt body before being joined together, wherein the belt body is closed to form the continuous belt by joining the two sections.

### BRIEF DESCRIPTION OF THE DRAWINGS

For a better understanding of the invention, it is explained in more detail with the aid of the following figures.

The figures show in a simplified, schematic representation:

FIG. 1 a perspective view of a continuous belt;

FIG. 2 a joint region of two free end sections of a belt body of the continuous belt from FIG. 1 with a covered welding gap during the application of a fluxing agent;

FIG. 3 the region in FIG. 2 after applying the fluxing agent and removing the cover;

FIG. 4 a section along line IV-IV in FIG. 1; and

FIG. 5 a section along line V-V in FIG. 1.

### DETAILED DESCRIPTION OF PREFERRED EMBODIMENTS

By way of introduction, it should be noted that in the various embodiments described, the same parts are provided with the same reference signs or the same component designations, wherein the disclosures contained in the entire description can be transferred analogously to the same parts with the same reference signs or the same component designations. Moreover, the specifications of location, such as at the top, at the bottom, at the side, chosen in the description refer to the directly described and depicted figure and in case of a change of position, these specifications of location are to be analogously transferred to the new position.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

The figures are described comprehensively below.

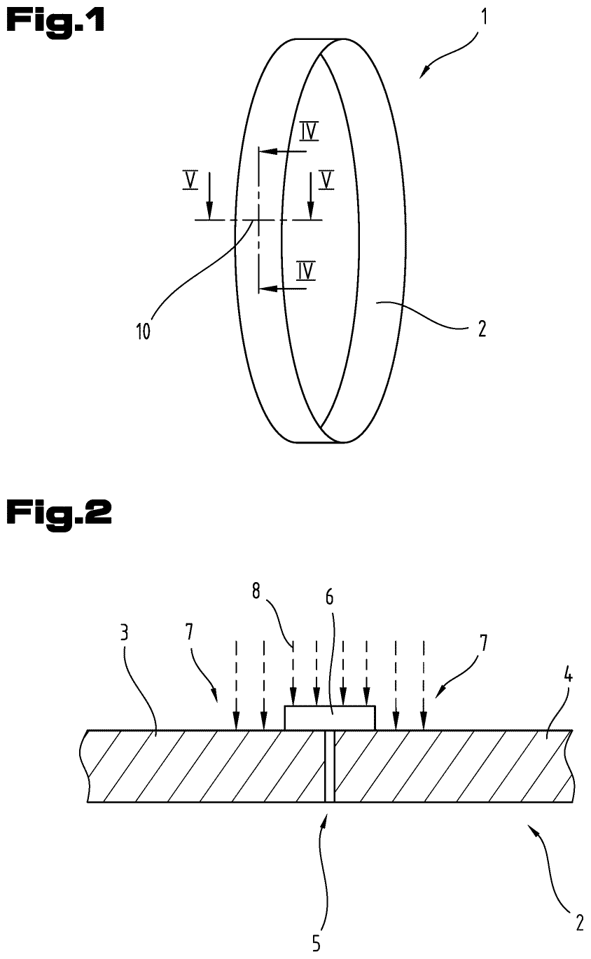

According to FIG. 1, a continuous belt 1 comprises a belt body 2 made of metal. The continuous belt 1 may have a circumferential length of 2 m-300 m and a belt width of 1200 mm-9000 mm. The belt body 2 is particularly preferably made of a steel comprising 12.0%-28.0% Cr, 3.5%-15.0% Ni, 0%-14% Cu, 0%-1% Ti, 0%-2% Si, 0%-2% Mn, 0%-6% Mo, 0%-2% N and a maximum of 0.01%-0.20% C.

Furthermore, the continuous belt 1 may have a tensile strength of 1000 N/mm²-1800 N/mm².

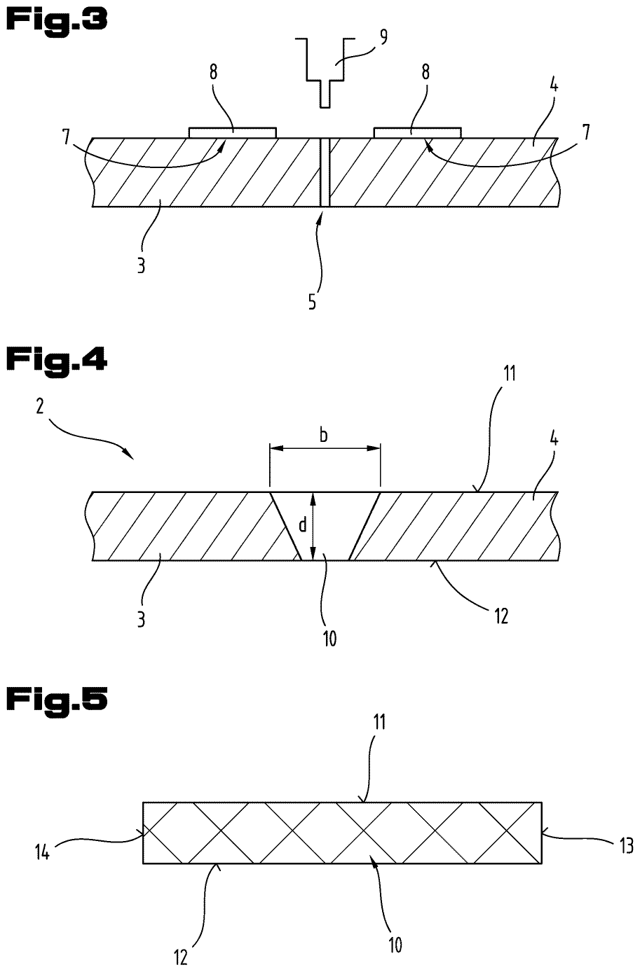

To produce the continuous belt 1, at least two sections 3, 4 of the belt body 2 are connected together by welding, as shown in FIGS. 2 and 3. The sections 3, 4 may form free end regions of the belt body 2 before they are joined together. By connecting the two sections 3, 4, the belt body can be closed to form the continuous belt 1. However, it is also possible for the continuous belt 1 to be separated to form an open belt, for example during maintenance or repair of the continuous belt 1, and then closed again by welding the sections 3, 4. One of the sections 3, 4 may also be inserted as a replacement part into an opening previously made in the belt body 2 during processing of the continuous belt 1. For example, when repairing a belt, a damaged part of the belt body 2 may be cut out and replaced with an undamaged piece of sheet metal.

Before the sections 3, 4 are welded together, a welding gap 5 formed in an abutting region of the at least two sections 3, 4 is covered with a cover 6 in step i). The cover 6 may completely cover the welding gap 5 over its entire length and width. The cover 6 may be a film, in particular a plastic film, preferably an adhesive tape or plastic belt. Preferably, the cover 6 is a transparent film with a transmittance of between 20% and 99%. The transparency of the cover 6 makes it easier to align the cover 6 precisely along the welding gap 5. The fact that the cover 6 has a width of between 2 mm and 150 mm transverse to a longitudinal course of the welding gap 5 has proven to be particularly advantageous in terms of manageability and optimization of the fluxing agent 8 requirement.

In a step ii), a fluxing agent 8 is applied to at least one region 7 of the belt body 2, said region directly adjoining to the cover 6 and not being covered by the cover 6. It has been proved to be particularly advantageous with regard to through-welding and achieving a very good welding seam quality that the fluxing agent 8 applied in step ii) comprises 20-60% by weight TiOₓ and/or 0-5% by weight Cr₃Oₓ.

As shown in FIG. 2, the fluxing agent 8 may be applied to the surface of the belt body 2 as viewed in the longitudinal direction of the cover 6 on both longitudinal sides of the cover 6.

The fluxing agent 8 is applied to regions 7 of the surface of the belt body 2 to the left and right of the cover 6, viewed in the longitudinal direction of the cover 6. Even if it has proven to be particularly advantageous to apply the fluxing agent 8 to both regions 7 located to the side of the cover 6, as shown in FIG. 2, it may also be sufficient to apply the fluxing agent 8 to only one region 7 located to the left or right of the cover 6.

The fluxing agent 8 may be applied, for example, by spraying and/or brushing and/or rolling and/or printing. As the welding seam 5 is protected by the cover 6, the fluxing agent 8 can also come into direct contact with the cover 6 during application.

In a subsequent step iii), the cover 6 is removed. As may be seen in FIG. 3, there is no fluxing agent 8 in the region of the welding gap 5 after removing the cover 6. The fluxing agent 8 is only present in regions 7 that are directly adjoining to the region that was previously covered by the cover 6. If the cover 6 has very straight longitudinal edges, a very straight line of a front of the fluxing agent 8 on the edge of the fluxing agent 8 facing the welding gap 5 can also be achieved.

After removing the cover 6, the two sections 3, 4 are welded together along the welding gap 5 in step iv) by means of a welding device 9. It has proven to be particularly advantageous if a TIG welding process, a PA welding process, a MIG welding process, a MAG welding process, a laser welding process or a plasma welding process is used in step iv).

According to FIG. 1, the welding seam 10 obtained with the method according to the invention may be a welding seam running transversely or obliquely to a circumferential direction of the continuous belt 1, wherein the belt body 2 can be closed to the continuous belt 1 by the welding seam.

As may be seen in FIG. 4, the welding seam 10 has a ratio of a thickness d to a maximum width b of greater than or equal to 1:4, in particular greater than or equal to 1:3, 1:2 or 2:3.

The welding seam 10 may have a maximum width b of 2 mm-10 mm, in particular between 5 mm and 10 mm, particularly preferably between 7 mm and 8 mm. The belt body 2 may have a thickness of 0.8 mm-4 mm, for example. Furthermore, the belt body 2 has a first main surface 11 and a second main surface 12.

As may be seen in FIG. 5, the first main surface 11 and the second main surface 12 are connected to one other via side surfaces 13, 14. As may also be seen in FIG. 5, the welding seam 10 runs across the entire width of the belt body 2.

According to FIG. 4, the thickness d of the welding seam 10 extends from the first main surface 11 of the belt body 2 to the second main surface 12. The welding seam 10 may be, for example, a square groove weld, a single-V groove weld or an open single-V butt joint.

Finally, as a matter of form, it should be noted that for ease of understanding of the structure, elements are partially not depicted to scale and/or are enlarged and/or are reduced in size.

### LIST OF REFERENCE SIGNS

1 Continuous belt
2 Belt body
3 Section
4 Section
5 Welding gap
6 Cover
7 Region
8 Fluxing agent
9 Welding machine
10 Welding seam
11 Main surface
12 Main surface
13 Side surface
14 Side surface

1. A method for producing and/or processing a continuous belt (1) comprising a belt body (2) made of metal, wherein at least two sections (3, 4) of the belt body (2) are connected together by welding, wherein prior to welding of the at least two sections (3, 4) a step i) is carried out in which a welding gap (5) formed in the abutting region of the at least two sections (3, 4) is covered by a cover (6), wherein in a subsequent step ii) is carried out in which a fluxing agent (8) is applied in one region (7) of the belt body (2), said region directly adjoining the cover (6) and not being covered by the cover (6), wherein in a subsequent step iii), the cover (6) is removed, and in a step iv), the at least two sections (3, 4) are welded together along the welding gap (5), wherein the cover has a width transverse to a longitudinal course of the welding gap of between 2 mm and 150 mm.

2. The method according to claim 1, wherein the cover (6) is a film, in particular a plastic film, preferably an adhesive tape or plastic belt, the film preferably being a transparent film with a transmittance of between 20% and 99%.

3. (canceled)

4. The method according to claim 1, wherein the fluxing agent (8) applied in step ii) comprises 20-60% by weight TiOₓ and/or 0-5% by weight Cr₃Oₓ.

5. The method according to claim 1, wherein the fluxing agent (8) is applied by spraying and/or brushing and/or rolling and/or printing.

6. The method according to claim 1, wherein in step iv) a TIG welding process, a PA welding process, a MIG welding process, a MAG welding process, a laser welding process or a plasma welding process is used.

7. The method according to claim 1, wherein the at least two sections (3, 4) form free end regions of the belt body (2) before being joined together, the belt body being closed to form the endless belt (1) by joining the two sections (3, 4).

8-15. (canceled)
